(19) United States
(12) Patent Application Publication
(10) Pub. No.: US 2014/0034719 A1
(43) Pub. Date: Feb. 6, 2014

(54) COMPUTER READABLE TARTAN SYSTEM

(71) Applicants: Ricardo A. Summers, Baltimore, MD (US); Robert D. Summers, JR., Chicago, IL (US)

(72) Inventors: Ricardo A. Summers, Baltimore, MD (US); Robert D. Summers, JR., Chicago, IL (US)

(21) Appl. No.: 13/562,326

(22) Filed: Jul. 31, 2012

(51) Int. Cl. G06K 19/06; G06Q 90/00

(52) U.S. Cl. 235/375; 235/494

(57) ABSTRACT

The computer readable tartan (CRT) system, method and product provide an effective and efficient way to generate a humanly recognizable and computer readable code (CRC) using at least two distinct colors. The CRT system, method and product more specifically provide a way to generate a computer readable tartan that is humanly recognizable and improves the functional relevance of CRCs.

### TECHNICAL FIELD

The present description relates to an effective and efficient way to generate a humanly recognizable and computer readable code (CRC) using at least two colors. This description more specifically relates to how to generate a computer readable tartan that is humanly recognizable and improves the functional relevance of CRCs.

### BACKGROUND

Merchants and consumers are currently attempting to understand how to incorporate computer readable code (CRC) technology into more mainstream uses for consumers, in order to provide increased interactions by consumers between the real and digital worlds (e.g., the Internet).

For example, a Quick Response Code (QR Code®) is a type of matrix barcode (or two-dimensional code) designed in Japan for the automotive industry by the Toyota subsidiary Denso Wave in 1994 to track vehicles during the manufacturing process. The QR code is detected as a 2-dimensional digital image by a semiconductor image sensor and digitally analyzed by a programmed processor. The QR code consists of black modules (squares) arranged in a square pattern on a white background.

The processor locates the distinctive markers in the area of the CRC. The components (e.g. pixels of contrasting colors in color areas) of the CRC are converted to binary numbers and checked with an error-correcting code.

As another example, Microsoft® provides a High Capacity Color Barcode (HCCB) (used to implement Microsoft® tag's mobile tagging application) that encodes data in a 2-dimensional barcode using clusters of colored triangles instead of square pixels as associated with 2D barcodes such as QR codes®. Microsoft® Tag uses four colors in a 5×10 grid, but also works in monochrome.

Consumers find CRCs humanly unrecognizable and functionally obtrusive, although CRC technology is accessible to most internet-capable mobile devices, including many CRC technologies based on the Windows® Phone 7, Windows® Mobile, BlackBerry®, Java®, Android®, Symbian® S60, iPhone® and Java® ME platforms. CRC technologies provide a way to use the on-board camera of a mobile device to capture an image of a CRC and to be directed to multimedia content, such as text, vCard, URL, on-line photographs, on-line video and contact information for others. Accordingly, increased consumer use of CRCs may be constrained without a way to make CRCs functionally relevant to and humanly recognizable by consumers.

### SUMMARY

The computer readable tartan (CRT) system, method and product provide a way to generate a computer readable tartan that is humanly recognizable and improves the functional relevance of CRCs for mainstream consumer use. The CRT system uses one or more CRCs of one or more CRC types to generate one or more CRTs. The CRT system includes a communications interface, a memory coupled to a processor and the communications interface.

The memory includes CRT logic configured to cause the processor to receive one or more computer readable codes (CRCs) of one or more CRC types, and retrieve previously stored CRCs of multiple CRC types. The CRC types identify a number of color areas (e.g., in a two color areas CRC—positive space and negative space) for the CRC. The CRC type identifies a luminosity color contrast ratio threshold for the color areas (e.g., a minimum contrast ratio for the CRC to be properly read/scanned by a CRC reader/scanner).

The CRT logic receives, via the communications interface, one or more tartan patterns for selection by a user (e.g., merchant, consumer and/or subscriber). Subscribers may include merchants, advertisers and consumers and the systems and/or applications of the merchants, advertisers and consumers. A merchant may communicate one or more tartan patterns for selection, one or more CRCs for selection, or a combination thereof. A user (e.g., consumer or merchant) may communicate one or more tartan patterns for selection, one or more of CRCs for selection, or a combination thereof. A subscriber (e.g., a user with access to tracking and campaign management features for CRCs and CRT generated by the CRT system) may receive compensation when a CRT (e.g., a merchant sponsored CRT) is scanned by a CRC scanner device.

The CRT logic may retrieve and communicate for selection previously stored tartan patterns. A tartan is a pattern of interlocking color areas arrange both horizontally and vertically. Each tartan includes metadata that identifies the number of colors for the tartan, default colors assignments for the tartan, and dimensions of the colors of the tartan. The CRT logic may also receive from the user and/or another system a size/ratio assignment for each of the default colors for the tartan, and dimensions of the default colors for the tartan, and receive color-to-size assignments for each of the colors of the tartan. A user may confirm selection of the default color-to-size assignments for the tartan or select one or more colors different from the default colors and color-to-size assignments for the tartan in order to customize the CRT the CRT system generates.

The CRT system and/or logic receive CRC scanner device statistical metrics including scanner error rates for one or more CRC types for one or more scanner/reader devices, and scanner capabilities of the scanner devices used to scan previously scanned CRCs. The CRT system and/or logic analyze the CRC scanner device statistical metrics to identify the most probable one or more scanner devices that may be expected to scan the more or more CRCs of a generated CRT and the capabilities of the CRC scanner device. The CRT system and/or logic may adjust the colors areas contrast ratio thresholds and the percent of error correction thresholds for selection in order to ensure that the one or more CRCs of the CRT are accurately scannable by a CRC scanner/reader device.

The CRT logic analyzes color contrast ratio thresholds for the colors areas of the CRC types based on the scanner device statistical metrics, adjusts the color contrast ratio thresholds used to calculate ranges of default color combinations to communicate for selection for the one or more CRCs, and calculates the ranges of default color combinations to communicate for selection for the one or more CRCs based on the color contrast ratio thresholds. The CRT logic communicates, via the communications interface, the ranges of default color combinations for selection for the types of CRCs selected for generating the CRT.

In one implementation, the value of the color contrast ratio thresholds may be based on the number of color areas of the CRCs used. For example, the value of the color contrast ratio thresholds for a two colors areas CRC 102 (e.g., QR codes®) may be different for a five colors areas CRC (e.g., Microsoft® Tags) used to generate a CRT, in order to reduce scan errors. CRC types that use more colors areas than other CRCs types (e.g., five colors areas CRC versus two colors areas CRCs 102) may dictate the color contrast ratio thresholds for the colors areas of the CRCs.

For each of the colors of the tartan, the CRT system and logic may receive color areas assignments for the CRC (e.g., the positive and negative space for a two colors areas—two dimensional CRC), a tartan orientation selection (e.g., 0 to 360 degree rotation about an axis), a tartan size selection (e.g., width and height dimensions), a CRC orientation selection (e.g., 0 to 360 degree rotation about an axis), a CRC minimum size selection (e.g., width and height dimensions of 1.25 inches square), or any combination thereof. The CRT logic generates the CRT based on the size/ratio assignments selections, the color combinations selected for the one or more CRCs (e.g., a CRT may be generated that incorporates multiple CRC types), and communicates the generated CRT for display on a graphical interface display area (e.g. the mobile device of a person interested in making contact with the wearer or source of the CRC).

The CRT logic and/or a user assigns one or more actions (e.g., redirect a mobile device's browser to a URL or create an email message to a configured email address) for the CRT to cause to be performed by a processor when the CRT is scanned by a CRC scanner device (e.g., mobile device configured with a CRC reader/scanner application). The CRT logic provides a way to perform multiple actions simultaneously, or in sequence, triggered by scanning the CRC (e.g., generated CRT). The CRT system and logic provide a subscriber a way to modify, in real-time, the assigned one or more actions for the CRT to perform when the CRT is scanned by a CRC scanner device.

Other systems, methods, and features will be, or will become, apparent to one with skill in the art upon examination of the following figures and detailed description. It is intended that all such additional systems, methods, features and be included within this description, be within the scope of the disclosure, and be protected by the following claims.

### BRIEF DESCRIPTION OF THE DRAWINGS

The computer readable tartan (CRT) system may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 shows a computer readable code (CRC) loader/generator display for the computer readable tartan (CRT) system.

FIG. 2 shows a display interface with tartan selector and size/ratio formula selector.

FIG. 3 shows a flow diagram of logic the CRT system may use to determine the size/ratio assignments for the colors of the selected tartan.

FIG. 4 shows a CRT generated by the CRT system.

FIG. 5 shows a display interface with color selectors to change the default displayed colors of the tartan.

FIG. 6 shows a display interface with CRC colors areas selectors, and CRC color selection preview display area.

FIG. 7 shows a flow diagram of logic the CRT system may use to communicate the CRC colors areas selectors and color selection preview display area, and receive and store CRC colors areas assignments.

FIG. 8 shows a display interface with a CRT color selection preview display area, tartan orientation selector and tartan size selector.

FIG. 9 shows a flow diagram of logic the CRT system may use to perform an action when the CRT is scanned by a CRC scanner.

FIG. 10 shows a configuration of the CRT system.

FIG. 11 shows a CRT selector display interface that includes a subscribe selector, login selector and CRT action selector.

FIG. 12 shows a subscriber account display interface.

FIG. 13 shows a subscriber CRT campaign management display interface.

FIG. 14 shows a subscriber CRT analytics dashboard.

FIG. 15 shows action types assignments parameters to configure a CRT.

FIG. 16 shows wireless network access authorization action type assignment configuration parameters to configure a CRT.

FIG. 17 shows Vcard action assignment configuration parameters to configure a CRT.

FIG. 18 shows other action types assignments parameters to configure a CRT.

### DETAILED DESCRIPTION

The principles described herein may be embodied in many different forms. Not all of the depicted components may be required, however, and some implementations may include additional, different, or fewer components. Variations in the arrangement and type of the components may be made without departing from the spirit or scope of the claims as set forth herein. Additional, different or fewer components may be provided.

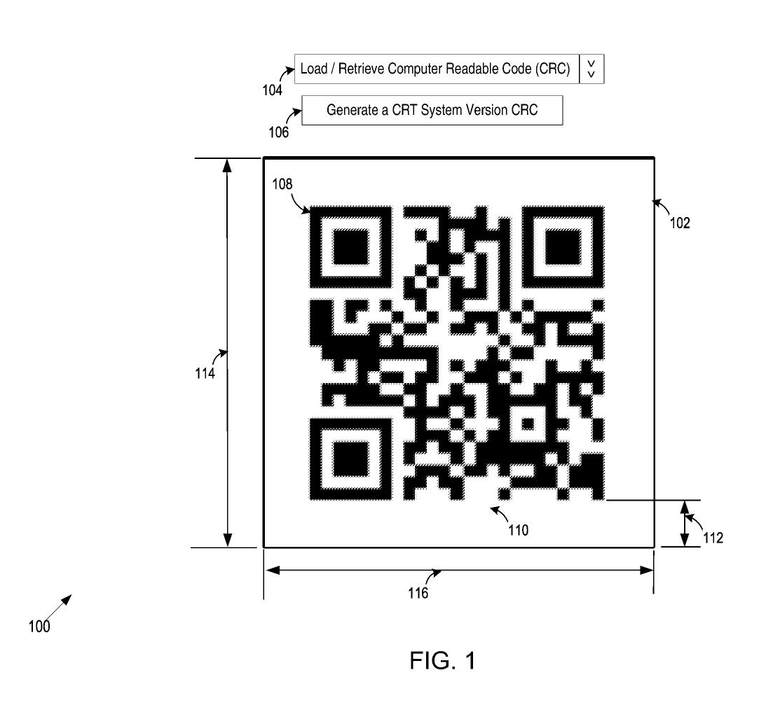

FIG. 1 shows a computer readable code (CRC) loader/generator 100 display for the computer readable tartan (CRT) system. Loader may receive multiple CRCs (102) to generate multiple corresponding CRTs. For example, the CRT system provides a way to generate multiple CRTs with a common CRT color scheme but implemented with different CRCs.

The CRT system provides a way to combine one or more CRCs to generate a humanly recognizable and computer readable tartan. The user may select combinations of different types of CRCs (e.g., QR code®, and Microsoft® tags) to use to generate a CRT.

The CRT system may analyze the color contrast ratio thresholds for the color combinations useable to generate each of the one or more CRCs and error correction properties of the one or more CRCs to determine the color combinations to provide for selection to generate CRTs. Although the CRT system is directed to generating and managing CRTs, the CRT system may be adapted to generate any number of humanly recognizable multi-colored patterns (e.g., madras and argyle) that include CRCs.

The CRT system includes a communications interface, a memory coupled to a processor and the communications interface. The memory includes CRT logic configured to cause the processor to receive one or more computer readable codes (CRCs) 102 of one or more CRC types, and retrieve previously stored CRCs of multiple CRC types. A user may upload one or more CRCs selected using the load/retrieve CRC selector 104 and/or generate one or more CRCs using the generate CRT system version CRC selector 106.

The CRC types identify a number of color areas (108, 110) (e.g., in a two color areas CRC such as a QR code—positive space 110 and negative space 108) for the CRC, and the width of the quiet area (e.g., white space) 112 around a CRC 102. The CRC type identifies a color contrast ratio threshold for the color areas (e.g., a minimum contrast ratio for the different color areas of the CRC 102 in order to be accurately read/scanned by a CRC reader/scanner—such as a contrast ratio greater than 4:1). The CRC type identifies minimum opacity levels for each of the color areas, a minimum size of the CRC (114, 116) (e.g., 1.25 inch square), range of saturation and brightness within each hue (HSB) values (color areas 108, 110), used to describe the relationship among the colors areas, the dynamic range of saturation and brightness for each of the color hues.

The CRT system provides color ranges for selection for the multiple color areas of the CRC 102 and minimum size suggestions. The CRT system may prompt the user with one or more suggested selections when a selected color for a color area of the CRC 102 does not satisfy the color contrast ratio threshold for the color areas of the CRC 102, and/or when the user attempts to generate a CRT that does not include at least one CRC color size assignment that satisfies the minimum CRC size threshold. In this way, the CRT system ensures that one or more CRCs used to generate the CRT are accurately scannable.

The CRT system analyzes a CRC 102 to determine whether the CRC was previously generated by the CRT system or another source (e.g., a CRC generator external to the CRT system). When a subscriber loads a CRC generated by another source, the CRT system generates a CRT system version of the CRC (e.g., a redirectable CRC that uses Domain Name System (DNS) to replicate the action type of the CRC generated by another source) so that the subscriber may change the action types, track and manage the CRT system version CRC and CRT generated with the CRT system version CRC. The CRT system generates a CRT system controlled web page (e.g., URL default destination) to assign to a CRT system version CRC, and CRT logic determines actions to take when the CRT system version CRC is scanned by a CRC scanner.

For example, a user may upload a CRC generated by another source that directs a CRC scanner to a URL, and the action of the CRC may be static (e.g., the action type cannot be changed). The user may generate a CRT using the CRC generated by another source, and manage the CRC and CRT through another system. Alternatively, the user may generate a CRT system version CRC so that if the user is a subscriber, the subscriber may manage and/or change the action type in real-time for the CRT system version CRC and CRT generated using the CRT system version CRC.

The CRT system may retrieve contrast information from CRC scanner generators and reader systems and applications to adjust the contrast thresholds, and receive CRC scanner device trends information (e.g., error rates and CRC scanner capabilities for devices used to scan CRCs) in order to adjust the color contrast ratio thresholds used to determine the default color combinations to use for CRCs to generate CRTs.

The CRT system may provide selectable color ranges for the colors areas of the CRC used to generate the CRT, in order to obtain colors areas assignments (e.g., two colors areas, a foreground and background, of a two colors areas CRC type) that satisfy one or more color contrast ratio thresholds. For example, many CRC scanner devices and applications may expect a CRC foreground (e.g., first colors area) to be darker than the background (e.g., second colors area), and the CRC scanner devices and applications may not correctly read a CRC with a background (e.g., second colors area) that is darker than the foreground (e.g., first colors area). The CRT system may provide selectable color ranges for the colors areas of the CRC to improve the quiet-area borders of the CRC so that CRC scanner devices accurately scan the CRT generated using the CRC.

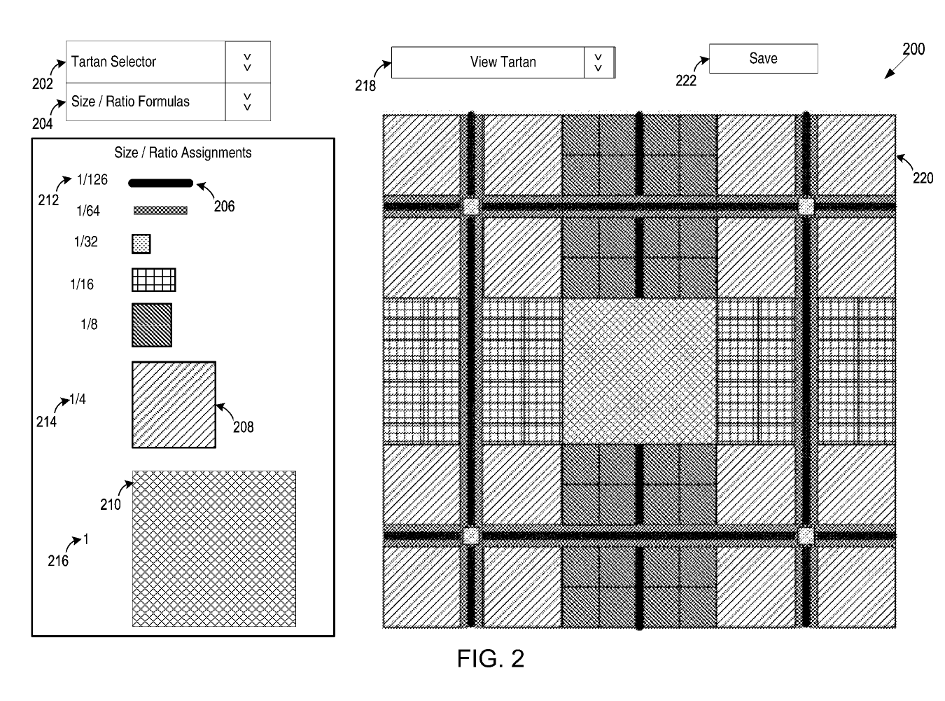

FIG. 2 shows a display interface 200 with tartan selector 202 and size/ratio formula selector 204. The CRT system and/or logic receive, via the communications interface, one or more tartan patterns for selection by a user (e.g., merchant, consumer and/or subscriber). A merchant may communicate one or more tartan patterns for selection, one or more CRCs for selection, one or more CRTs or a combination thereof. Merchants and advertisers may provide tartans for selection and/or CRCs for users to select in order to generate one or more CRTs. A subscriber may receive redeemable credits or monetary return from the merchants and/or advertisers when the CRT is scanned by a CRC scanner.

A user (e.g., subscriber, consumer or merchant) may communicate one or more tartan patterns for selection, one or more CRCs for selection, one or more CRTs or a combination thereof. A subscriber (e.g., a user with a login the tracking and campaign management features provided by the CRT system for the CRCs and CRTs generated by the CRT system) may receive compensation when a generated CRT (e.g., a merchant sponsored CRT) is scanned by a CRC scanner device.

The CRT logic may retrieve and communicate for selection previously stored tartan patterns. Each tartan includes metadata that identifies the number of colors for the tartan, default colors assignments for the tartan, and dimensions of colors areas for the tartan.

The user may select a size/ratio formula from the size/ratio formula selector 204 in order to modify the size (206, 208, 210) and/or ratio assignments (212, 214, 216) for the colors areas of the selected tartan. The CRT logic may also receive from the user and/or another system a size/ratio assignment for each of the default colors areas of the tartans, and dimensions of the default colors areas for the tartans, and receive color-to-size assignments for each of the colors of the tartans. The user may save the default color-to-size assignments for the tartan or select one or more different color-to-size assignments. The user/subscriber may select the view tartan selector 218 to view updates to the tartan 220 to the color-to-size assignments selected by the user (206, 208, 210), and/or select another tartan to use to generate one or more CRT. The user/subscriber may select the save 222 selector to save the color and size ratio assignments to use to generate one or more CRT.

The CRT system and/or logic receive CRC scanner device statistical metrics including scanner error rates for one or more CRC types for one or more scanner devices, and scanner capabilities of the scanner devices used to scan previously scanned CRCs. The CRT system and/or logic analyze the CRC scanner device statistical metrics to identify the most probable one or more scanner devices that may be expected to scan the one or more CRCs of a generated CRT and the capabilities of the CRC scanner device. The CRT system and/or logic may use the CRC scanner device statistical metrics to determine the size/ratio formulas to apply to obtain the size/ratios for the tartan colors areas used to assign CRC colors areas assignments (discussed below).

For example, the CRT system may determine that at least one of the color size assignments to be represented by a CRC is at least equal to or greater than a configured minimum CRC size threshold (e.g., 1.25 inches), and when the user attempts to generate a CRT that does not include at least one CRC color size assignment that satisfies the minimum CRC size threshold, the CRT system may provide a suggested color size assignment and/or prompt the user to adjust at least one of the color size assignments in order to generate a CRT. The minimum CRC size threshold may be configured based on CRC scanner device statistical metrics, the CRC type or the combination thereof.

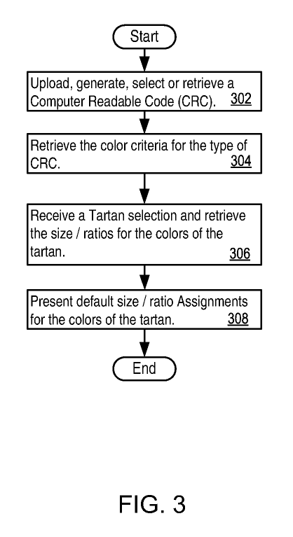

FIG. 3 shows a flow diagram 300 of logic the CRT system may use to determine the size/ratio assignments for the colors of the selected tartan. The CRT system uploads, receives or retrieves one or more CRC selections (302). The user/subscriber may also generate one or more CRCs to use to generate one or more CRTs. The CRT system and/or logic retrieve the color criteria for the type of CRC (e.g., QR code®, Microsoft® tag) (304). The user/subscriber selects a tartan to use to assign size and color assignments to the one or more CRCs used to generate a CRT (306) and the CRT system and/or logic retrieve and communicate the size/ratios for the colors of the selected tartan to the user (308).

The CRT logic analyzes color contrast ratio thresholds for the CRC types based on the scanner device statistical metrics, adjusts the color contrast ratio thresholds used to calculate ranges of default colors areas combinations (e.g., positive space and negative space combinations for two colors areas CRCs) to communicate for selection by the user for the one or more CRCs, and calculates the ranges of default color areas combinations to communicate for selection for the one or more CRCs based on the color contrast ratio thresholds. The CRT logic communicates, via the communications interface, the ranges of default color areas combinations for selection for the types of CRCs selected for generating the CRT.

In one implementation, the color contrast ratio thresholds may be based on the number of color areas of the CRCs used. For example, the color contrast ratio thresholds for a two colors areas CRC (e.g., QR codes®) may be different for a five colors areas CRC (e.g., Microsoft® Tags) to generate a CRT, in order to reduce scan errors. CRC types that use more colors areas than other CRCs types may determine the color contrast ratio thresholds selectable to use for the colors areas of the CRCs.

For each of the colors of a selected tartan, the CRT system and/or logic may receive color areas assignments for the CRC (e.g., the positive and negative space for a two colors areas—two dimensional CRC), a tartan orientation selection (e.g., 0 to 360 degree rotation about an axis), a tartan size selection (e.g., width and height dimensions), a CRC orientation selection (e.g., 0 to 360 degree rotation about an axis), a CRC minimum size selection (e.g., width and height dimensions of 1.25 inches square), or any combination thereof. The CRT logic generates the CRT based on the size/ratio assignments selections, the colors areas combinations selected for the one or more CRCs (e.g., a CRT may be generated that incorporates multiple CRC types), and communicates the generated CRT for display on a graphical interface display area (e.g. the mobile device of a person interested in making contact with the source of the CRC used to generate the CRT).

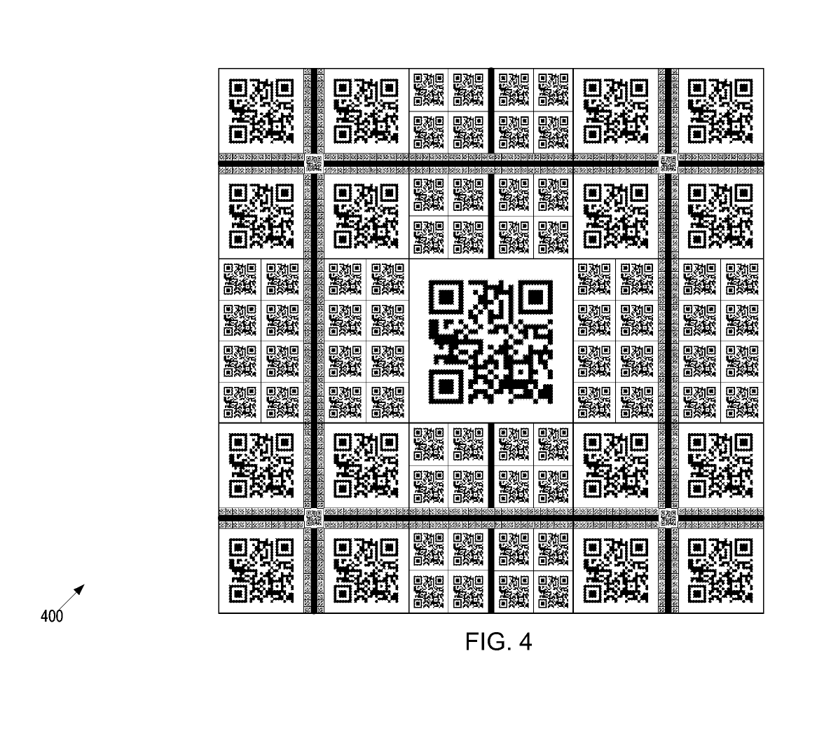

FIG. 4 shows a computer readable tartan (CRT) 400 generated by the CRT system using the selected CRC and selected tartan. The various sizes of the CRC and colors areas assignments used to generate the CRT correspond to the tartan color and size metadata for the selected tartan.

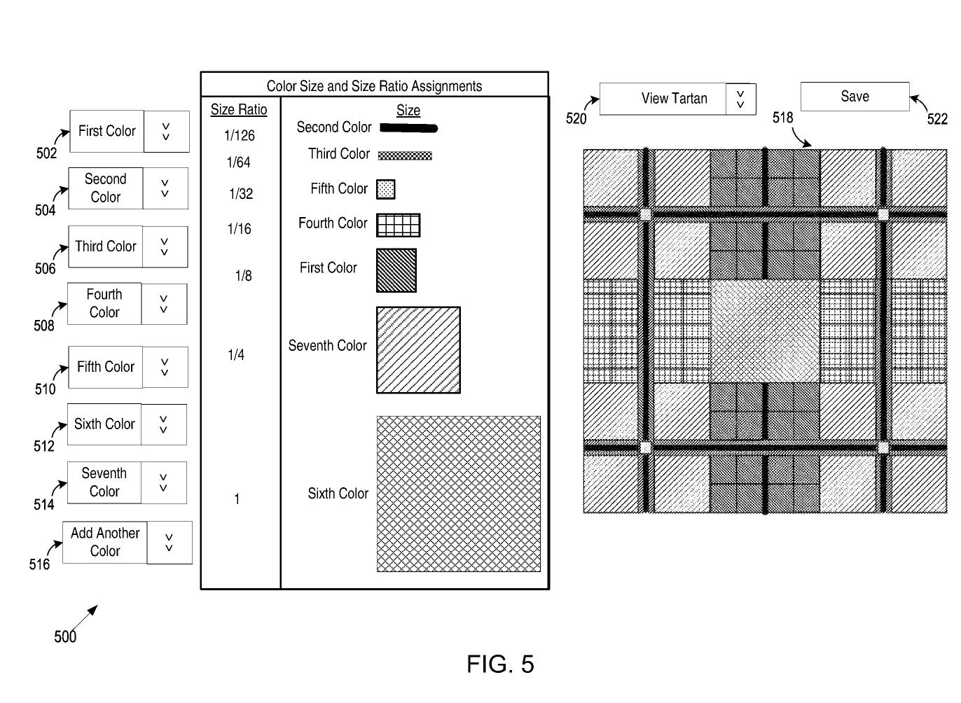

FIG. 5 shows a display interface 500 with color selectors (502, 504, 506, 508, 510, 512, 514, 516) to change the default colors of the selected tartan 518. The user/subscriber may select the view tartan selector 520 to view updates to the colors selected using the color selectors (502, 504, 506, 508, 510, 512, 514, 516), and/or select another tartan to use to generate a CRT. The user/subscriber may select the save 522 selector to save color and size ratio assignments to use to generate a CRT.

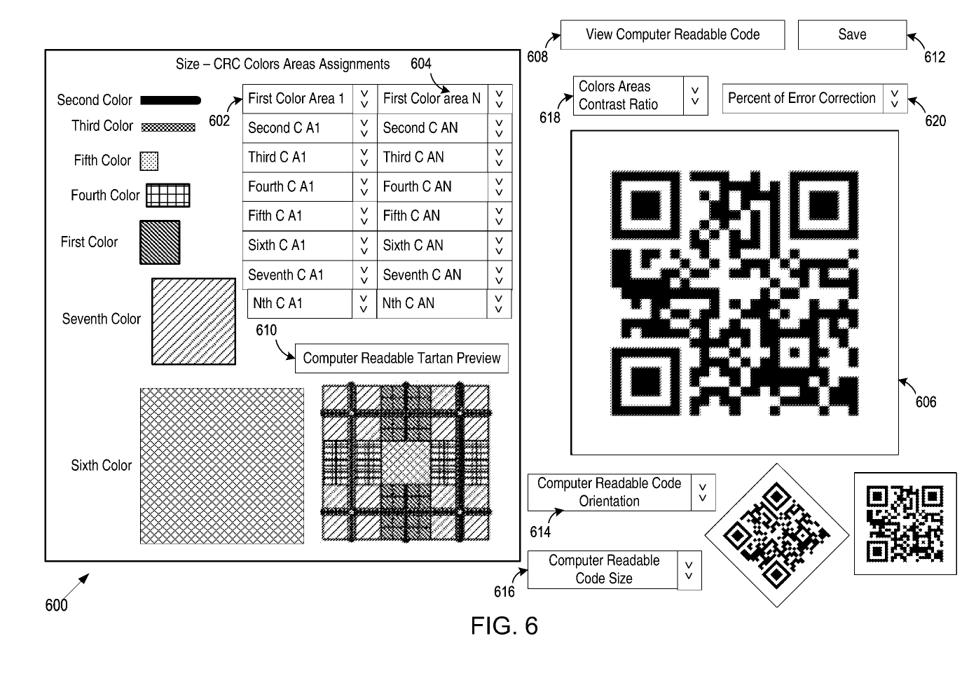

FIG. 6 shows a display interface 600 with CRC colors areas selectors (602, 604), and a CRC color selection preview display area 606. The CRT system communicates CRC colors areas selectors (602, 604) for each colors areas of the CRC type for each of the colors of the selected tartan. For example, a five colors areas CRC and a seven colors tartan, the CRT system communicates five CRC colors areas selectors (e.g., first color area 1, first color area 2, first color area 3, first color area 4 and first color area 5) for each of the seven colors of the tartan.

The user may select the view CRC selector 608 to evaluate the CRC colors areas assignments. For example, a user/subscriber may scan the CRC to confirm the scannability of the CRC configured with the CRC colors areas assignments. The display interface 600 may also communicate the CRT preview 610 to display the CRT using the CRC colors areas assignments of the CRC. The user/subscriber may select the save 612 selector to save the CRC colors areas assignments. The user/subscriber may also select, for each size—color assignment of the CRT, the CRC orientation selector 614 to orient the CRC 0 to 360 degrees in the colors area assigned, and select the CRC size selector 616 to set a size for the color size assignment for the CRC. Modifying the color size assignment for a CRC with the CRC size selector 616 may correspondingly modify the size of the color area corresponding to the color size assignment. For example, increasing the size of the CRC for a color size assignment of the color ‘red’ increases the ‘red’ color areas in the CRT.

The CRT system and/or logic provides a colors areas contrast ratio selector 618 that adjusts the range of colors areas selections (602, 604) available that satisfy the colors areas contrast ratio selected so that a user may select, for example, a foreground color area color (602) for a first color of a selected tartan and the CRT system determines a range of selectable background color area colors (604) that satisfy the colors areas contrast ratio. The CRT system and/or logic provide a percent of error correction selector 620 that a user may select to determine the colors areas contrast ratios to communicate for selection from the colors areas contrast ratio selector 618. The colors areas contrast ratio selector 618 and percent of error correction selector 620 assist the user to select colors areas assignments that ensure the one or more CRCs of the CRT are accurately scannable by a CRC scanner/reader device.

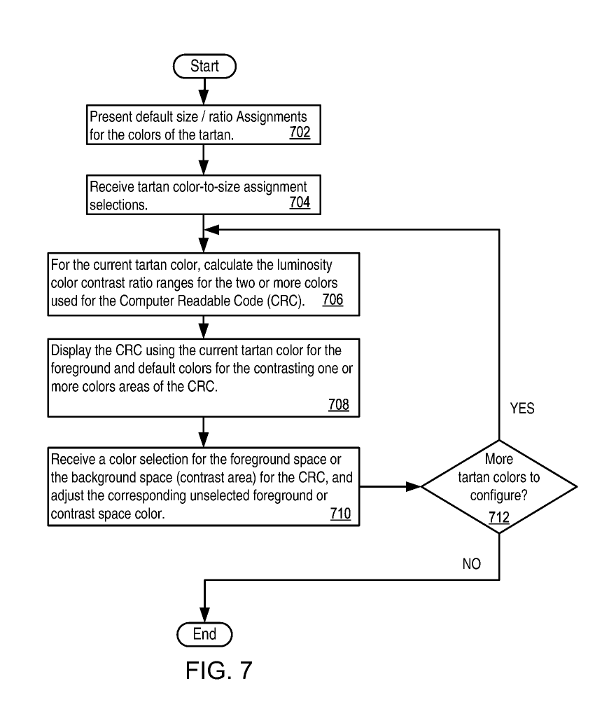

FIG. 7 shows a flow diagram 700 of logic the CRT system may use to communicate the CRC colors areas selectors, and color selection preview display area, and receive and store CRC colors areas assignments. The CRT system and/or logic present (communicate) default size/ratio assignments for the colors of a selected tartan (702) for a user to preview, change and/or save. The CRT system and/or logic receive tartan color-to-size assignment selections from the user (704), and store the color selections for the CRC, the tartan and/or a CRT so that another tartan may be subsequently selected and another CRT generated based on the previously configured CRC colors areas assignments. In this way, a user may quickly generate different CRTs using different tartan color assignments based on the CRC colors areas assignments previously saved.

For each of the colors of the selected tartan, the CRT system and/or logic calculate the color contrast ratio ranges for the two or more colors used for the CRC (706). For each of colors of the selected tartan, the CRT system and/or logic display the CRC using the current tartan color for a first colors area of the CRC (e.g., foreground) and default colors for the contrasting one or more other colors areas of the CRC (e.g., two colors areas CRCs versus five colors areas CRCs) (708). For each of colors of the selected tartan, the CRT system and/or logic may receive a color selection for the first colors area of the CRC (e.g., foreground) and/or the one or more contrasting color areas of the CRC, and adjust, based on the selected color, the corresponding unselected one or more contrasting color areas of the CRC (710). In this way, the CRT system and/or logic provide the user/subscriber a way to review and save the color selections for the first colors area of the CRC (e.g., foreground) color and/or the one or more contrasting color areas of the CRC for each color of the selected tartan (712).

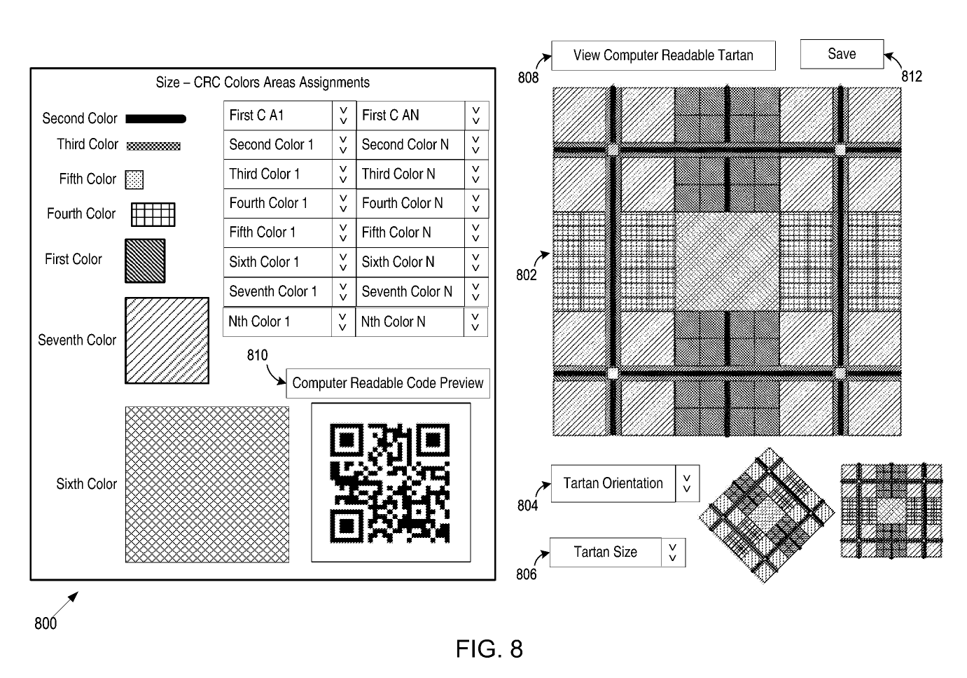

FIG. 8 shows a display interface 800 with a CRT color selection preview display area 802, a tartan orientation selector 804 and tartan size selector 806. The user may select the view CRT selector 808 to evaluate the CRT generated using the size and CRC colors areas assignments. For example, a user/subscriber may scan the CRT to confirm the scannability of the CRT configured with the CRC colors areas assignments. The display interface 800 may also communicate the CRC preview 810 to display the CRC used to generate the CRT. The user/subscriber may select the save 812 selector to save and/or generate the CRT.

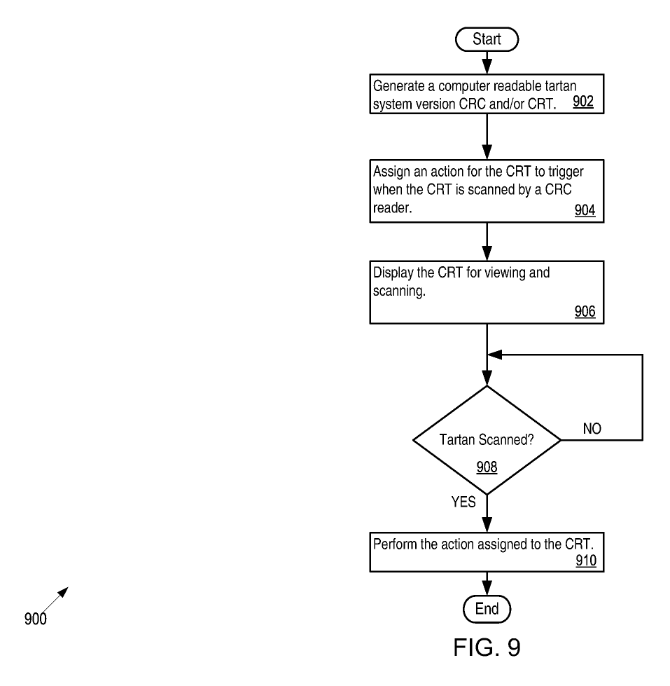

FIG. 9 shows a flow diagram 900 of logic the CRT system may use to perform an action when the CRT is scanned by a CRC scanner. The CRT system and/or logic generate a CRT system version CRC and CRT generated using the CRT system version CRC (902). A user uses the CRT system and/or logic to assign (configure) an action (904) for the CRT to trigger (e.g., cause a processor to perform) when the CRT is scanned by a CRC reader. A user/subscriber may display the CRT for viewing and scanning (908). For example, the user/subscriber may create, purchase and/or sell (e.g., a merchant—user) an item with the CRT applied to the surface area of the item (906), and when the CRT is scanned by a CRC reader. The CRT system and/or logic perform the action assigned to the CRT (910).

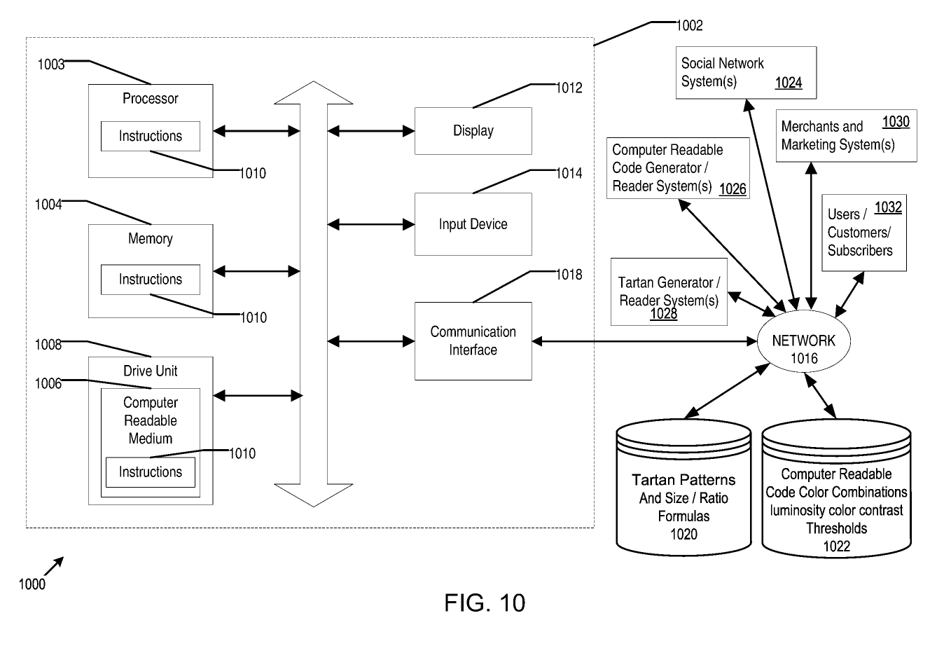

FIG. 10 shows a configuration 1000 of the CRT system. The CRT system 1002 may be deployed as a general purpose computer system used in a networked deployment. The CRT system may include a tartan patterns and size/ratio formulas database 1020 and CRC color combinations color contrast thresholds database 1022. The CRT system may communicate with one or more social network systems and applications 1024, CRC generators and reader systems and applications 1026, tartan generators and readers 1028, and merchants and advertisers 1030. The CRT system may use information from various sources to assist users 1032 (customers, subscribers) to generate CRCs and CTRs. The CRT system may receive metrics and statistical information and values for the tartan patterns and size/ratio formulas and CRC color combinations color contrast thresholds from the one or more social network systems and applications 1024, CRC generators and reader systems and applications 1026, tartan generators and readers 1028, and merchants and advertisers 1030.

The computer system may operate in the capacity of a server or as a client user computer in a server-client user network environment, or as a peer computer system in a peer-to-peer (or distributed) network environment. The computer system may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1010 (sequential or otherwise) that specify actions to be taken by that machine. In a particular embodiment, the computer system may be implemented using electronic devices that provide voice, video or data communication. Further, while a single computer system may be illustrated, the term “system” shall also be taken to include any collection of systems or sub-systems that individually or jointly execute a set, or multiple sets, of instructions to perform one or more computer functions.

The computer system may include a processor 1003, such as, a central processing unit (CPU), a graphics processing unit (GPU), or both. The processor may be a component in a variety of systems. For example, the processor may be part of a standard personal computer or a workstation. The processor may be one or more general processors, digital signal processors, application specific integrated circuits, field programmable gate arrays, servers, networks, digital circuits, analog circuits, combinations thereof, or other now known or later developed devices for analyzing and processing data. The processors and memories 1004 discussed herein, as well as the claims below, may be embodied in and implemented in one or multiple physical chips or circuit combinations. The processor 1003 may execute a software program 1010, such as code generated manually (i.e., programmed).

The computer system 1002 may include a memory 1004 that can communicate via a bus. The memory 1004 may be a main memory, a static memory, or a dynamic memory. The memory 1004 may include, but may not be limited to non-transitory computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor. Alternatively or in addition, the memory 1004 may be separate from the processor, such as a cache memory of a processor, the memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions executable by the processor. The functions, acts or tasks illustrated in the figures or described herein may be performed by the programmed processor executing the instructions stored in the memory. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system may further include a display 1012, such as a liquid crystal display (LCD), an organic light emitting diode (OLED), a flat panel display, a solid state display, a cathode ray tube (CRT), a projector, a printer or other now known or later developed display device for outputting determined information. The display 1012 may act as an interface for the user to see the functioning of the processor, or specifically as an interface with the software stored in the memory or in the drive unit.

Additionally, the computer system may include an input device 1014 configured to allow a user to interact with any of the components of system. The input device may be a number pad, a keyboard, or a cursor control device, such as a mouse, or a joystick, touch screen display, remote control or any other device operative to interact with the system.

The computer system may also include a disk or optical drive unit. The disk drive unit 1008 may include a computer-readable medium 1006 in which one or more sets of instructions, e.g. software, can be embedded. Further, the instructions may perform one or more of the methods or logic as described herein. The instructions may reside completely, or at least partially, within the memory 1004 and/or within the processor during execution by the computer system. The memory 1004 and the processor also may include computer-readable media as discussed above.

The present disclosure contemplates a computer-readable medium 1006 that includes instructions or receives and executes instructions responsive to a propagated signal, so that a device connected to a network 1016 may communicate voice, video, audio, images or any other data over the network 1016. Further, the instructions may be transmitted or received over the network 1016 via a communication interface 1018. The communication interface may be a part of the processor or may be a separate component. The communication interface may be created in software or may be a physical connection in hardware. The communication interface may be configured to connect with a network, external media, the display, or any other components in system, or combinations thereof. The connection with the network may be a physical connection, such as a wired Ethernet connection or may be established wirelessly as discussed below. Likewise, the additional connections with other components of the system 1002 may be physical connections or may be established wirelessly. In the case of a service provider server, the service provider server may communicate with users through the communication interface.

The network may include wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

The computer-readable medium 1006 may be a single medium, or the computer-readable medium 1006 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1006 may include a solid-state memory such as a memory card or other package that houses one or more non-volatile read-only memories. The computer-readable medium 1006 also may be a random access memory or other volatile re-writable memory. Additionally, the computer-readable medium 1006 may include a magneto-optical or optical medium, such as a disk or tapes or other storage device to capture carrier wave signals such as a signal communicated over a transmission medium. A digital file attachment to an email or other self-contained information archive or set of archives may be considered a distribution medium that may be a tangible storage medium. The computer-readable medium 1006 is preferably a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

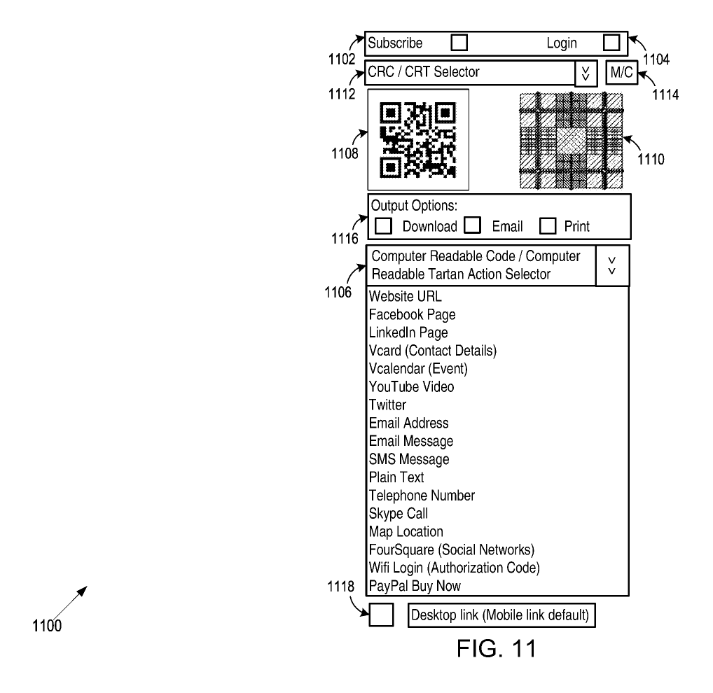

FIG. 11 shows a CRC/CRT selector 1100 display interface that includes a subscribe selector 1102, login selector 1104 and CRC/CRT action selector 1106. Although FIG. 11 shows one CRC 1108 and CRT 1110, the CRT system is configured to generate CRTs that implement multiple CRCs of the same or different CRCs types.

A user may select the subscribe selector 1102 to subscribe to the CRT system in order to track and manage the CRTs and/or CRCs. A subscriber may login to the CRT system by selecting the login selector 1104 to enter a login identifier and password. A subscriber may select a CRC and/or CRT using the CRC/CRT selector 1112, and manage and/or create one or more CRC/CRT by selecting the CRC/CRT manage/create selector 1114. When the user and/or subscriber select the CRC/CRT manage/create selector 1114, the CRT system communicates (displays) the CRC loader 100 and/or the tartan selector 200 so that the user and/or subscriber may select one or more CRCs and tartans to generate a CRT. When the CRT system generates a CRT, the user/subscriber may select one or more output options 1116 (e.g., download, email, print) to output the CRT and/or the one or more CRCs used to generate the CRT. The CRT system may configure the CRT to default to a mobile URL (redirect to the mobile device version of a URL—action type), unless the user/subscriber selects the desktop link option 1118.

A subscriber may use the CRC/CRT selector 1100 display interface to modify in real-time the configuration (e.g., action type) for a CRT system version CRC and/or CRT by selecting the CRT system version CRC and/or CRT from the CRC/CRT selector 1112 and selecting the CRC/CRT action selector 1106. For example, a subscriber may have a personal item (e.g., a neck tie and/or hand bag) with one or more CRT system version CRCs and/or CRTs, the subscriber may initially select the action type 1106 to communicate an email address and subsequently select the action type 1106 to communicate a URL based on the subscriber's preferences and without regenerating the CRT system version CRCs and/or the CRTs.

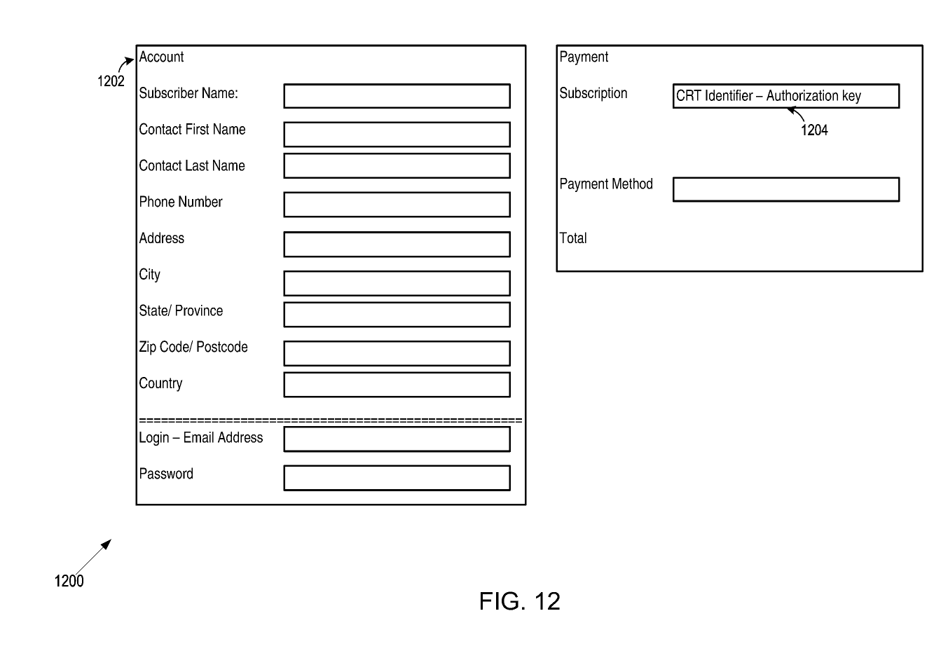

FIG. 12 shows a subscriber account 1200 display interface. For example, when a user creates/purchases an item (e.g., a scarf, a shirt, a hand bag or other items) that includes a CRT, the default action type may direct a CRC scanner to an information page (URL) about the item, with a hyperlink to subscribe and manage the CRT. The hyperlink to subscribe and manage the CRT may prompt the subscriber for a CRT identifier authorization key 1204. The CRT identifier authorization key 1204 may be communicated to the subscriber when the subscriber purchased the item with the CRT (e.g., a scarf, a shirt, a hand bag or other items that include the CRT). A CRC identifier authorization key 1204 may be communicated to the subscriber when the subscriber generates a CRT system version CRC.

When the CRT system receives the CRT and/or CRC identifier authorization key 1204, the CRT system may discontinue displaying the hyperlink that prompts a user to subscribe and manage a CRT. When the subscribers subscription for the CRT and/or CRC expires, the CRT system may revert to the default action type that directs a CRC scanner to an information page (URL) about the item and/or the CRT used with the item, with the hyperlink to renew and/or subscribe to manage the CRT (item). When the subscriber renews the subscription after expiration, the subscriber may be prompted to reenter the CRT/CRC identifier authorization key 1204. In this way, the CRT identifier authorization key 1204 provides the subscriber control of the CRT and avoids hacking the CRT by unauthorized parties (e.g., external systems, other subscribers and/or people).

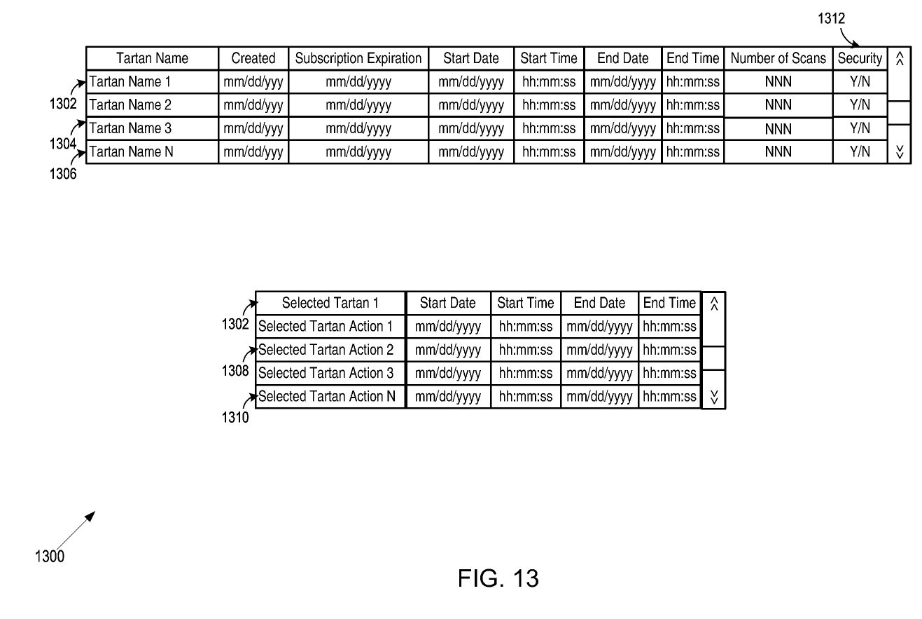

FIG. 13 shows a subscriber CRT campaign management 1300 display interface. A subscriber of the CRT system may manage multiple CRTs (1302, 1304, 1306) and/or CRCs (not shown) using the subscriber CRT campaign management 1300 display interface. The subscriber may assign (configure) different action types (1308, 1310, 1312) for the CRT 1302 to perform for different periods of time, and/or based on the location from which the CRT is scanned, and/or the type of location (e.g., work, home, event venue).

For example, the CRT may be configured to change action types every other time the CRT is scanned, on a configured interval of time (e.g., every 10 minutes change the URL where the CRT directs a scanner). In another example, the CRT system determines the action type based on the location of the CRT when scanned such as when the subscriber is on travel some configure number of miles from a configured location (e.g., home) the CRT may direct the scanner to an alternative URL to ensure the privacy of the subscriber and/or to minimize telecommunication charges (e.g., direct a CRC scanner to a local phone number to where the CRT is scanned where the user may be contacted and/or a message may be left for the subscriber).

The subscriber may set the CRT to secure mode 1312 so that a security prompt (e.g., authentication web page) is presented to a person (e.g., scanner on the person's mobile device) and/or external system (e.g., another application) scanning the CRT so that the person (entity) is required to authenticate their identity before the CRT system performs a configured action type (e.g., present the phone number or email address of the subscriber to the person).

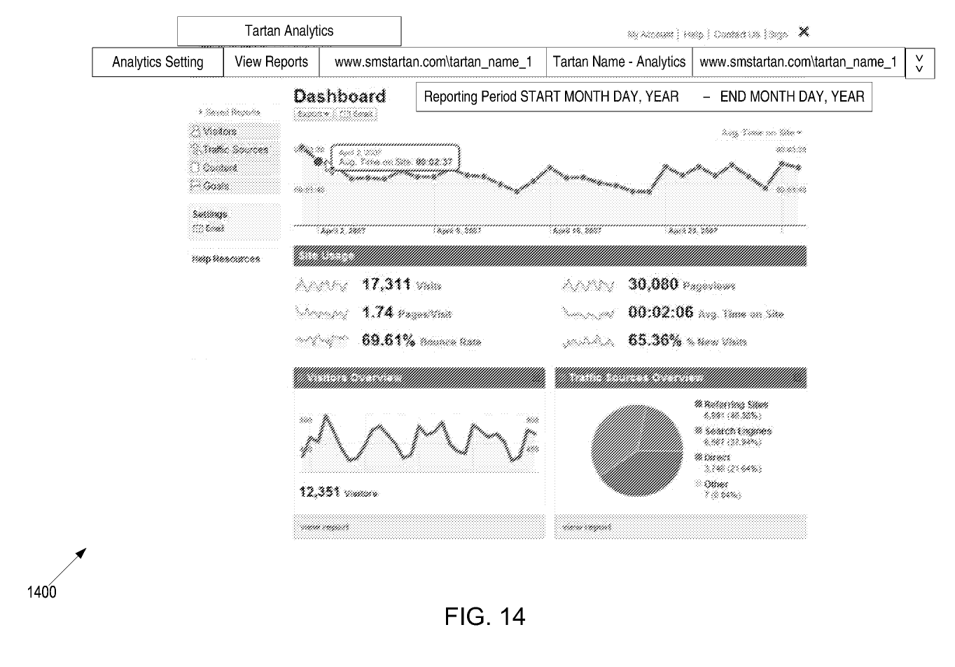

FIG. 14 shows a subscriber CRT analytics dashboard 1400. A subscriber of the CRT system may track metrics for one or more CRTs. The CRT analytics dashboard 1400 may provide reports and display views of statistical information for individual CRTs or multiple CRTs for a selected time period. In this way, the subscriber may identify trends, set and measure goals, such as, the countries and/or various locations the CRT is scanned. The subscriber may use the CRT to facilitate an increase in contacts on professional networks and/or social networks. The subscriber may configure the CRT analytics dashboard 1400 and/or metrics to be viewable by the contacts of the subscriber on professional networks and/or social networks.

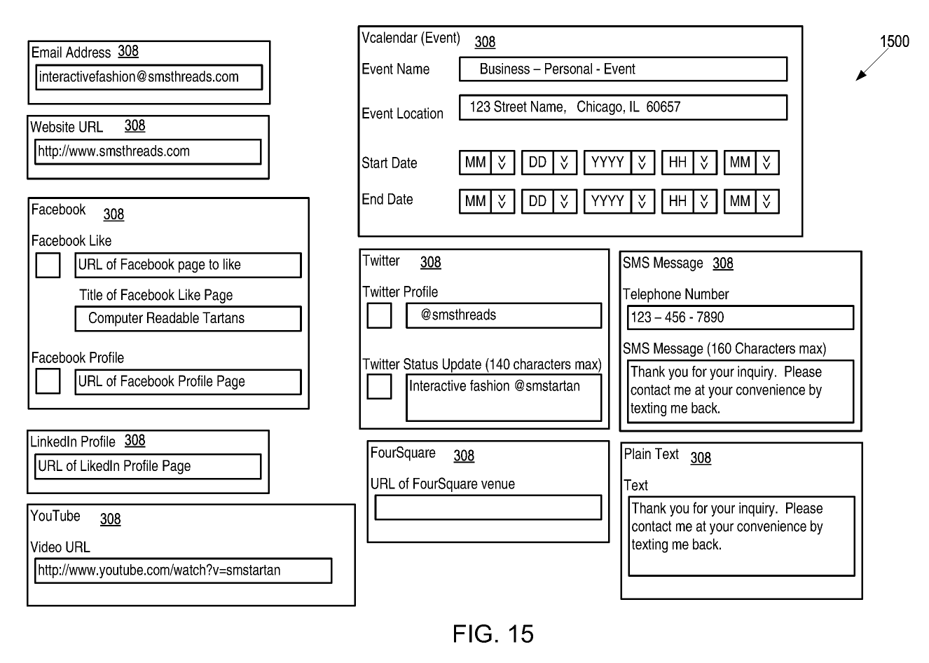

FIG. 15 shows action types assignments parameters 1500 to configure a CRT. The CRT logic and/or a user assigns one or more actions (e.g., a URL redirect or create an email message to a configured email address—where the CRT system may provide the email address to ensure the anonymity of the subscriber and forward emails to the subscriber) for the CRT to cause (trigger) to be performed by a processor when the generated CRT is scanned by a CRC scanner device (e.g., mobile device configured with a CRC reader/scanner application). The CRT logic provides a way to perform multiple actions simultaneously, or in sequence, triggered by scanning the CRC (e.g., generated CRT). The CRT system and logic provide a subscriber a way to modify, in real-time, the assigned one or more actions for the CRT (and/or CRT system version CRCs) to perform when the CRT is scanned by a CRC scanner device.

A user may configure a CRT so that when scanned the CRT causes a processor to communicate a hyperlink of an email address 1502, a website URL 1504, a Facebook® 1506 “Like” hyperlilnk or Facebook® profile, a Linkedin® profile 1508, a YouTube URL 1510, a Vcalendar event 1512, a Twitter® account 1514, a FourSquare URL 1516 (e.g., location), a simple message service (SMS) message 1518, or a plain text message 1520.

The CRT system provides many CRT action types. For example, a user/subscriber (e.g., merchant—parking lot owner) may use the CRT system to generate CRTs placed at parking spaces of a parking lot in order to provide a humanly recognizable CRT to drivers. A driver may park their vehicle in a parking space marked with a CRT, and scan the CRT with a CRC scanner (e.g., a mobile device configured with a CRC scanner application) before leaving the vehicle at the parking space so that the driver may visually observe the humanly recognizable CRT and receive the parking space information on the scanner device (e.g., location of the parking space and/or the level in the parking structure where the parking space is located). The driver may retrieve the parking space information from the drivers mobile device and/or recall the humanly recognizable CRT in order to efficiently return to the driver's vehicle. The CRT may also be used to pay parking fees by presenting a payment display interface on the mobile device of the driver when the CRT is scanned by the driver.

The CRT system may provide a CRT action type that communicates product information (e.g., garment care instructions, and where to have a product serviced and/or repaired), so that merchants may eliminate the need for a care instruction tag on products. The CRT system may provide a CRT action type that communicates announcements regarding the availability of accessories associated with an item that includes the CRT.

The CRT system may provide one or more a CRT action types that communicate the identity of a person wearing and/or in possession of an item that includes the CRT (e.g., children's clothing and/or toys such as dolls and stuffed animals) so that the CRT may be used to identify the person wearing and/or in possession of the item and identify the owner of property.

The CRT system provides a way to generate CRTs that memorialize events, for example, creating quilt swatches with CRTs, including: multi-paneled quilts to memorialize each month of a child's life (e.g., a baby's quilts with twelve panels), significant anniversaries and/or birthdays such as sixteen, twenty, twenty five, thirty, fifty years, and/or special events. The CRT system provides a way to generate CRTs to implement interactive multimedia scrap books so that because the CRTs are humanly recognizable each CRT is distinguishable by the human viewer. The CRT system provides merchants and consumers a way to incorporate CRTs into fashion, personal accessories and home furnishings including: cell phone covers; computer sleeves; backpacks, messenger bags, totes, luggage and purses. The CRT system provides a way to produce custom items for every consumer (e.g., multiple shirts with a common CRT color scheme but implemented with unique CRCs for each shirt).

The CRT system provides action types that may initiate communication between a designer (e.g., merchant) and customers (purchaser) and marketing/social media sources. The CRT system provides subscribers (e.g., designer's) a way to track, interact, market and sell directly to consumers with products that include CRTs.

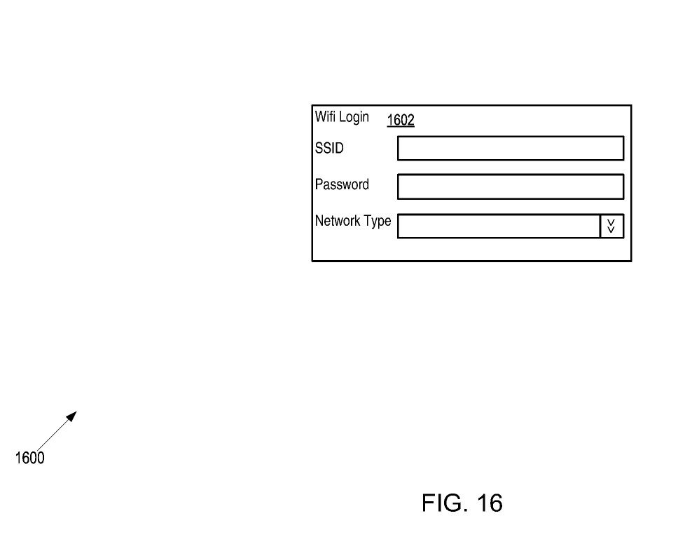

FIG. 16 shows wireless network access authorization action type assignment configuration parameters 1600 to configure a CRT. A user may assign the CRT to trigger a wireless network access authorization 1602 action type when the CRT is scanned by a CRC scanner device. For example, when a person with a CRC scanner device scans a CRT, the person may be prompted with a hyperlink to download the wireless network access authorization parameters.

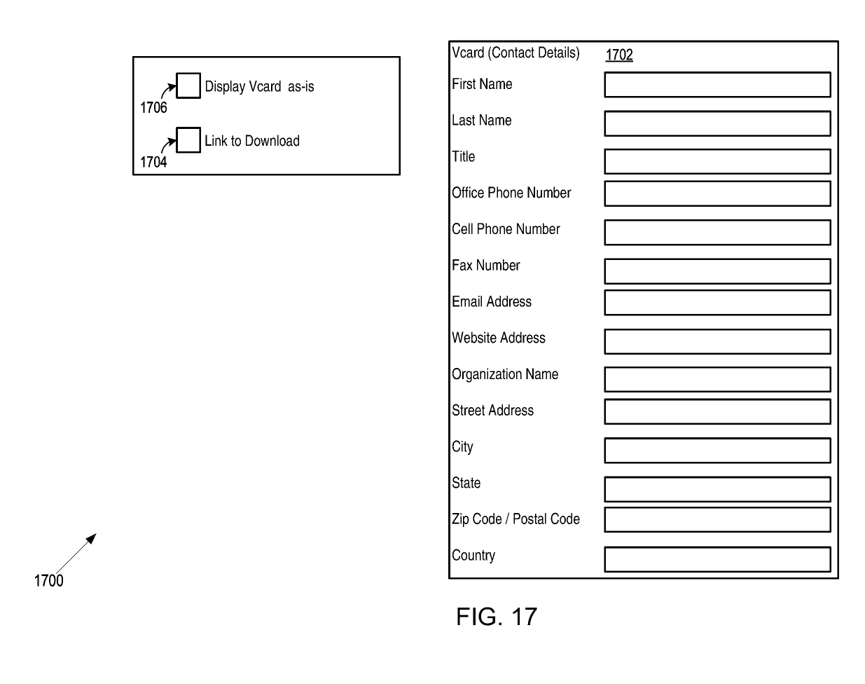

FIG. 17 shows Vcard action assignment configuration parameters 1700 to configure a CRT. A user may assign the CRT to trigger a Vcard 1702 action type when the CRT is scanned by a CRC scanner device. For example, when a person with a CRC scanner device scans a CRT, the person may be prompted with a hyperlink to download 1704 the Vcard configured by the user or view the Vcard 1706 with the option to download the Vcard.

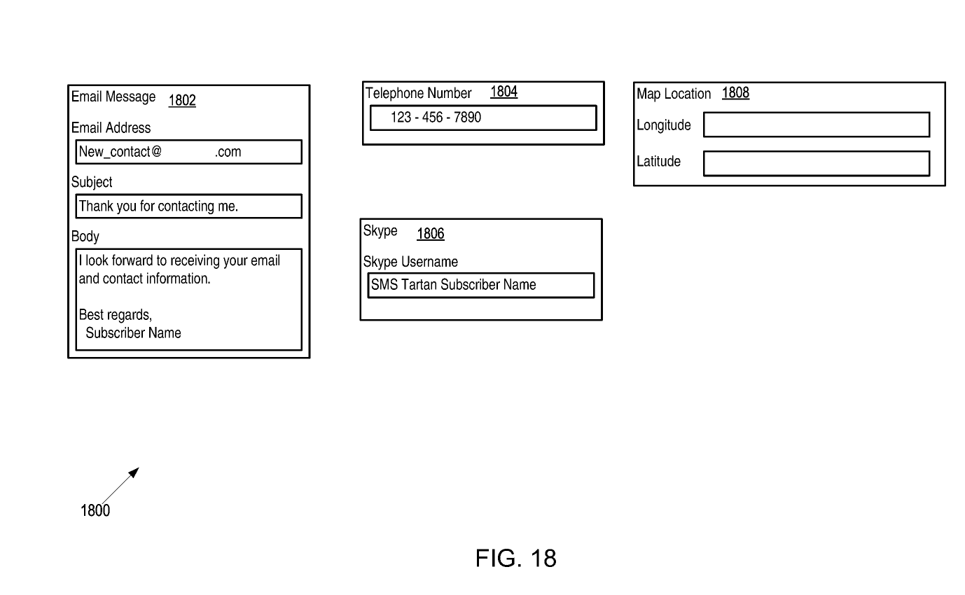

FIG. 18 shows other action types assignments parameters 1800 to configure a CRT. A user may assign the CRT to trigger an email message 1802 action type when the CRT is scanned by a CRC scanner device. For example, when a person with a CRC scanner device scans a CRT, the person may be prompted with a draft email message that the person may send to the user of the CRT. For privacy, the user may configure the email message to an email address (e.g., a CRT system provided email address) for the CRT so that the identity of the user (e.g., the personal email address of the subscriber) is not revealed by the email message. For example, the CRT system email address may forward emails to the subscribers personal email.

A subscriber may assign the CRT to trigger a phone number 1804 action type when the CRT is scanned by a CRC scanner device. For example, when a person with a CRC scanner device scans a CRT, the person may be prompted with a phone number to dial that the person may call the CRT configured phone number. For privacy, the subscriber may configure the phone number to a voice message box for the CRT so that the identity (e.g., personal phone number) of the user is not revealed by the phone number for the CRT. Also for privacy, the user may configure the phone number for the CRT to forward the call to the user's phone number so that the user may accept the phone call without revealing the identity (e.g., personal phone number) of the user. The CRT system may also include logic to redirect a phone call to a particular phone number based on the location of the CRT when the CRT is scanned to minimize telecommunication costs for the subscriber.

A user may assign the CRT to trigger a video call 1806 action type (e.g., Skype®) when the CRT is scanned by a CRC scanner device. For example, when a person with a CRC scanner device scans a CRT, the person may be prompted with a Skype® username to initiate a video call with the user of the CRT. For privacy, the user may configure the video call username (e.g., Skype® username) to an avatar for the user of the CRT so that the identity (e.g., personal phone number) of the user may not be revealed by the video call 1806 for the CRT. Also for privacy, the user may configure the video call username for the CRT to forward the video call to the user's personal video call username so that the user may accept the video call without revealing the identity (e.g., personal video call username) of the user.

A user may assign the CRT to trigger a map location 1808 action type (e.g., Google Map®) when the CRT is scanned by a CRC scanner device. For example, when a person with a CRC scanner device scans a CRT, the person may be prompted with a map location 1808 (longitude and latitude) hyperlink selectable to provide a location configured by the subscriber and/or directions to the configured location from the location where the scanner device scanned the CRT.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed:

1. A system comprising:
a communications interface;
a memory coupled to a processor and the communications interface, memory comprising:
computer readable tartan (CRT) system logic configure to cause the processor to:
receive one or more computer readable codes (CRCs) of one or more computer readable code types;
receive one or more tartan patterns;
receive, for each of the colors of the tartan, CRC color areas assignments for the CRC;
generate a CRT based on the CRC color areas assignments for the CRC;
communicate and display the generated CRT on a graphical interface display area; and
receive an assignment of at least one action to the CRT, wherein the assigned action identifies an action performed by a processor when the generated CRT is scanned by a CRC scanner.

2. The system of claim 1, wherein the logic is further configure to:
receive a size/ratio assignment for each of the default colors for the tartan, and dimensions of the default colors for the tartan;
receive color-to-size assignments for each of the colors of the tartan.

3. The system of claim 2, wherein the logic is further configure to:
receive CRC scanner device statistical metrics including: scanner error rates for the one or more CRC types for one or more scanner devices, and scanner capabilities of the scanner devices used to scan previously scanned CRCs;
analyze luminosity color contrast ratio thresholds for the CRC types based on the scanner device statistical metrics; and
adjust the luminosity color contrast ratio thresholds used to calculate ranges of default color combinations to communicate for selection for the one or more CRCs;

4. The system of claim 3, wherein the logic is further configure to:
calculate the ranges of default color combinations to communicate for selection for the one or more CRCs based on the luminosity color contrast ratio thresholds; and
communicate the ranges of default color combinations for selection for the one or more CRCs selected to generate the CRT.

5. The system of claim 1, wherein the logic is further configure to:
receive a tartan orientation selection, a tartan size selection, a CRC orientation selection, a CRC minimum size selection, or any combination thereof.

6. The system of claim 1, wherein the logic is further configure to:
retrieve previously stored CRCs of the one or more CRC types, wherein the CRC types identify a number of color areas for the CRC, wherein at least one CRC type comprises two color areas, wherein the at least one CRC type identifies a luminosity color contrast ratio threshold for the two color areas.

7. The system of claim 1, wherein at least one merchant communicates at least one of the tartan patterns for selection, at least one CRC for selection, or a combination thereof, wherein a user communicates at least one of the tartan patterns for selection, at least one CRC for selection, or a combination thereof, wherein a subscriber receives compensation when a generated CRT is scanned by a computer readable code scanner device.

8. The system of claim 1, wherein the logic is further configure to:
retrieve previously stored tartan patterns, wherein each tartan includes metadata including a number of colors for the tartan, default colors assignments for the tartan, and dimensions of the colors for the tartan.

9. The system of claim 2, wherein the color-to-size assignments confirm selection of the default colors for the tartan or identifies a selection of one or more colors different from the default colors for the tartan.

10. The system of claim 1, wherein the logic is further configure to:
receive and assign at least two actions to the CRT for the logic to cause the processor to perform when the generated CRT is scanned by a CRC scanner, wherein the processor performs the at least two actions simultaneously, or performs the at least two actions in sequence, wherein the subscriber modifies the assigned at least one action, or the assigned at least two actions.

11. A method comprising:
receiving and storing in a memory, using a communications interface, one or more computer readable codes (CRCs) of one or more computer readable code types;
receiving and storing in the memory one or more tartan patterns, wherein the tartan includes multiple colors;
receiving, for each of the colors of the tartan, CRC color areas assignments for the CRC;
generating a computer readable tartan (CRT) based on CRC color areas assignments for the CRC; and
communicating and displaying the generated CRT on a graphical interface display area.

12. The method of claim 11, further comprising:
assigning at least one action to the CRT, wherein the assigned action identifies an action performed by a processor when the generated CRT is scanned by a CRC scanner.

13. A product comprising:
a computer readable non-transitory memory, the memory comprising:
computer readable tartan (CRT) system logic configure to cause a processor to:
receive and store in the memory, using a communications interface, one or more computer readable codes (CRCs) of one or more computer readable code types;
receive and store in the memory one or more tartan patterns, wherein the tartan includes multiple colors;
receive, for each of the colors of the tartan, CRC color areas assignments for the CRC;
generate a computer readable tartan (CRT) based on CRC color areas assignments for the CRC; and
communicate and display the generated CRT on a graphical interface display area.

14. The product of claim 13, the CRT system logic further configure to: assign at least one action to the CRT, wherein the assigned action identifies an action performed by the processor when the generated CRT is scanned by a CRC scanner.

15. The product of claim 13, wherein the logic is further configure to:
receive a size/ratio assignment for each of the default colors for the tartan, and dimensions of the default colors for the tartan;
receive color-to-size assignments for each of the colors of the tartan.

16. The product of claim 15, wherein the logic is further configure to:
receive CRC scanner device statistical metrics including: scanner error rates for the one or more CRC types for one or more scanner devices, and scanner capabilities of the scanner devices used to scan previously scanned CRCs;
analyze luminosity color contrast ratio thresholds for the CRC types based on the scanner device statistical metrics; and
adjust the luminosity color contrast ratio thresholds used to calculate ranges of default color combinations to communicate for selection for the one or more CRCs;

17. The product of claim 16, wherein the logic is further configure to:
calculate the ranges of default color combinations to communicate for selection for the one or more CRCs based on the luminosity color contrast ratio thresholds; and
communicate the ranges of default color combinations for selection for the one or more CRCs selected to generate the CRT.

18. The product of claim 13, wherein the logic is further configure to:
receive a tartan orientation selection, a tartan size selection, a CRC orientation selection, a CRC minimum size selection, or any combination thereof.

19. The product of claim 13, wherein the logic is further configure to:
retrieve previously stored CRCs of the one or more CRC types, wherein the CRC types identify a number of color areas for the CRC, wherein at least one CRC type comprises two color areas, wherein the at least one CRC type identifies a luminosity color contrast ratio threshold for the two color areas.

20. The product of claim 13, wherein at least one merchant communicates at least one of the tartan patterns for selection, at least one CRC for selection, or a combination thereof, wherein a user communicates at least one of the tartan patterns for selection, at least one CRC for selection, or a combination thereof, wherein a subscriber receives compensation when a generated CRT is scanned by a computer readable code scanner device.
